(19) United States
(12) Patent Application Publication
(10) Pub. No.: US 2014/0372652 A1
(43) Pub. Date: Dec. 18, 2014

(54) SIMULATION CARD AND I2C BUS TESTING SYSTEM WITH SIMULATION CARD

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: SHOU-LI SHU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/190,141

(22) Filed: Feb. 26, 2014

(30) Foreign Application Priority Data
Jun. 14, 2013 (CN) 2013102340319

(51) Int. Cl. G06F 13/40; G06F 9/44

(52) U.S. Cl. CPC G06F 13/409; G06F 9/4411
USPC 710/301

(57) ABSTRACT

A simulation card is configured to insert into an insertion slot, and the insertion slot is connected to a main chip via an Inter-Integrated Circuit (I2C) bus. The simulation card includes a slave chip, a connecting unit, an address setting unit. The connecting unit is connected to the slave chip and the insertion slot. The address setting unit is coupled to the slave chip and configured to match an address of the slave chip with an address of the insertion slot. The slave chip is configured to be in communication with the main chip, to get signal transmission data of the I2C.

### FIELD

The present disclosure relates to I2C bus testing systems, and particularly relates to an I2C bus testing system with a simulation card.

### BACKGROUND

Functions of computer are expanded with an expansion card, such as an accelerated graphic display card, a video card, a network card, or a sound card, for example. The expansion card is inserted in a motherboard, and an Inter-Integrated Circuit (I2C) bus is sometimes used for data communication between a central processing unit (CPU) and the expansion card. During manufacturing of the motherboard, testing of the I2C bus is done using expansion cards which are discarded after periodic testing which is costly. Therefore, there is a need for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block view of an embodiment of an I2C testing system.

FIG. 2 is a circuit view of a simulation card of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

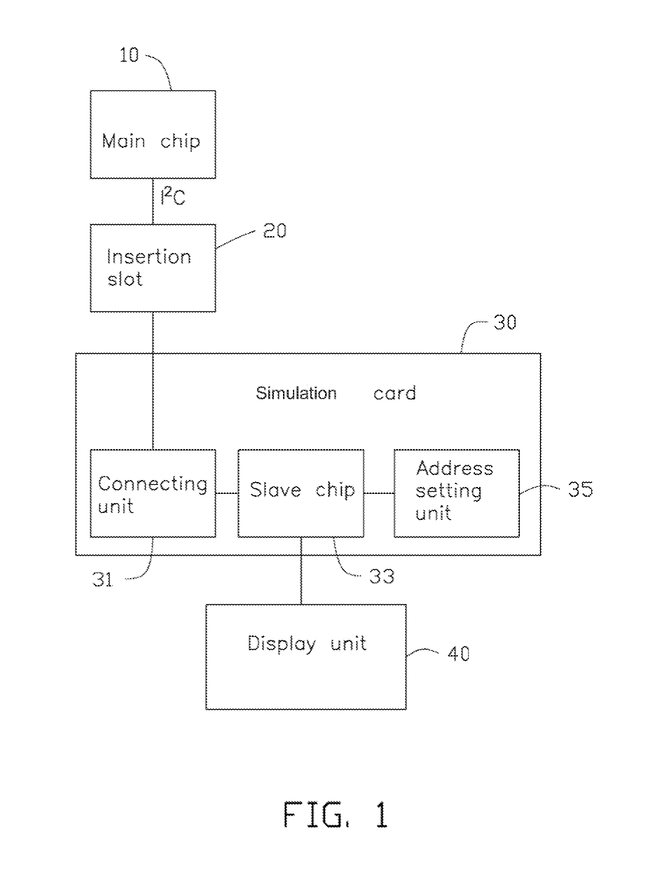

FIG. 1 shows one embodiment of an Inter-Integrated Circuit (I2C) bus testing system. The I2C bus testing system includes a main chip 10, an insertion slot 20, a simulation card 30, and a display unit 40. The main chip 10 is configured to be in communication with the simulation card 30 and send a controlling command to the simulation card 30. The insertion slot 20 receives the simulation card 30. The function of the simulation card 30 is the same as an expansion card, such as an accelerated graphic display card, a video card, a network card, or a sound card, for example. The simulation card 30 includes a connecting unit 31, a slave chip 33, and an address setting unit 35.

The connecting unit 31 connects the insertion slot 20 to the slave chip 33. The address setting unit 35 sets an address of the slave chip 33 to match the address of the slave chip 33 with an address of the insertion slot 20, such that the main chip 10 can establish communication with the slave chip 33, to get transmission data of the I2C bus.

The display unit 40 is connected to the slave chip 33 and displays the transmission data of the I2C bus. In one embodiment, the main chip 33 is a central processing unit (CPU), the number of the insertion slot 20 is eight, and each of the insertion slot 20 has an address. The display unit 40 is an oscilloscope.

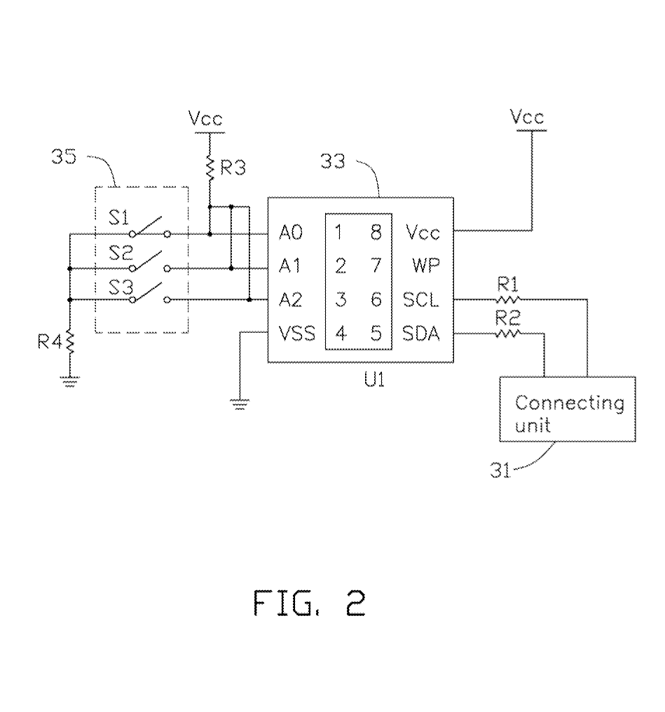

In FIG. 2, the connecting unit 31 is a gold finger (not shown). and can be inserted into the insertion slot 20. The slave chip 33 includes a first address setting port A0, a second address setting port A1, a third address setting port A2, a serial clock input port (SCL), a serial data input and output port (SDA), a work voltage port (Vcc), and a ground port (Vss). The first address setting port A0, the second address setting port A1, and the third address setting port A2 are coupled to the address setting unit 35. The SCL is coupled to the connecting unit 31 via a first resistor R1 and receives a clock signal of the main chip 10. The SDA is coupled to connecting unit 31 via a second resistor R2 and receives a data signal of the main chip 10. Vcc is 3.3V, and Vss is grounded. In one embodiment, the model of slave chip 33 is CAT24C03.

The address setting unit 35 includes a first switch S1, a second switch S2, and a third switch S3. The first switch Sl, the second switch S2, and the third switch S3 are in parallel and corresponding to the first address setting port A0, the second address setting port A1, and the third address setting port A2. A first end of the first switch S1 is coupled to the first address setting port A0 and the work voltage via a third resistor R3. A second end opposite to the first end of the first switch S1 is grounded via a fourth resistor R4. A first end of the second switch S2 is coupled to the second address setting port A1 and the work voltage via the first resistor R3. A second end opposite to the first end of the second switch S2 is grounded via the fourth resistor R4. A first end of the third switch S3 is coupled to the third address setting port A2 and the work voltage via the third resistor R3. A second end opposite to the first end of the third switch S3 is grounded via the third resistor R4.

In one embodiment, two predetermined address rules are defined in the slave chip 33, and the two predetermined address rules are 10100000 and 10100001. The two address rules are illustrated from right to left as follows. When the first bit going from right to left is zero, the main chip 10 reads data from the slave chip 33. When the first bit is one, the main chip 10 writes data into the slave chip 33. The second to fourth bits are corresponding to the first address setting port A0, the second address setting port A1, and the third address setting port A2 in turn. The fifth to eighth digitals are preset and not changed. The simulation card 30 is inserted into the insertion slot 20 with an address A4. The first switch S1 and the third switch S3 are switched off, and the second switch S2 is switched on, so that the first address setting port A0 and the third address setting port A2 have a low level and the second address setting portion A1 has a high level. Thus, when the main chip 10 searched the slave chip 33 with address of 10100100 or 10100101, the main chip 10 can establish communication with the slave chip 33.

The main chip 10 sends a controlling command to the slave chip 33, and the slave chip 33 receives the controlling command from the SDA and the SCL. The slave chip 33 sends back a signal to the main chip 10. End user can check the communication data of the 12C bus from the display unit 40.

The simulation card 30 thereby replaces an expansion card, such as an accelerated graphic display card, a video card, a network card, or a sound card, for example.

Even though numerous characteristics and advantages of the present disclosure have been set forth in the foregoing description, together with details of the structure and function of the disclosure, the disclosure is illustrative only, and changes may be made in detail, especially in the matters of shape, size, and the arrangement of parts within the principles of the disclosure to the full extent indicated by the broad general meaning of the terms in which the appended claims are expressed.

What is claimed is:

1. A simulation card configured to be inserted into an insertion slot, and the insertion slot being connected to a main chip via an Inter-Integrated Circuit (I2C) bus, the simulation card comprising:
a slave chip;
a connecting unit connected to the slave chip and the insertion slot; and
an address setting unit coupled to the slave chip and configured to match an address of the slave chip with an address of the insertion slot,
wherein the slave chip is configured to be in communication with the main chip, to get signal transmission data of the I2C.

2. The simulation card of claim 1, wherein the slave chip comprises a serial clock input port, and the serial clock input port is coupled to the connecting unit via a first resistor.

3. The simulation card of claim 1, wherein the slave chip comprises a serial data input and output port, and the serial data is coupled to the connecting unit via a second resistor.

4. The simulation card of claim 1, wherein the slave chip comprises a first address setting port, the address setting unit comprises a first switch, and a first end of the first switch is coupled to a work voltage via a third resistor, and a second end opposite to the first end of the first switch is grounded via a fourth resistor.

5. The simulation card of claim 4, wherein the slave chip comprises a second address setting port, the address setting unit comprises a second switch, and a second end of the second switch is coupled to a work voltage via a third resistor, and a second end opposite to the second end of the second switch is grounded via a fourth resistor.

6. The simulation card of claim 5, wherein the slave chip comprises a third address setting port, the address setting unit comprises a third switch, and a third end of the third switch is coupled to a work voltage via a third resistor, and a second end opposite to the third end of the third switch is grounded via a fourth resistor.

7. An I2C bus testing system comprising:
a main chip;
an insertion slot connected to the main chip via an I2C bus; and
a simulation card comprising:
a slave chip;
a connecting unit connected to the slave chip and the insertion slot; and
an address setting unit coupled to the slave chip and configured to match an address of the slave chip with an address of the insertion slot,
wherein the slave chip is configured to be communication with the main chip, to get signal transmission data of the I2C bus.

8. The I2C bus testing system of claim 7, further comprising a display unit, wherein the display unit is configured to display the signal transmission data.

9. The I2C bus testing system of claim 7, wherein the slave chip comprises a serial clock input port, and the serial clock input port is coupled to the connecting unit via a first resistor.

10. The I2C bus testing system of claim 7, wherein the slave chip comprises a serial data input and output port, and the serial data is coupled to the connecting unit via a second resistor.

11. The I2C bus testing system of claim 7, wherein the slave chip comprises a first address setting port, the address setting unit comprises a first switch, and a first end of the first switch is coupled to a work voltage via a third resistor, and a second end opposite to the first end of the first switch is grounded via a fourth resistor.

12. The I2C bus testing system of claim 11, wherein the slave chip comprises a second address setting port, the address setting unit comprises a second switch, and a second end of the second switch is coupled to a work voltage via a third resistor, and a second end opposite to the second end of the second switch is grounded via a fourth resistor.

13. The I2C bus testing system of claim 12, wherein the slave chip comprises a third address setting port, the address setting unit comprises a third switch, and a third end of the third switch is coupled to a work voltage via a third resistor, and a second end opposite to the third end of the third switch is grounded via a fourth resistor.

14. The I2C bus testing system of claim 7, wherein the main chip is a central processing unit, and the simulation card is an expansion card.
